(19) United States
(12) Patent Application Publication
(10) Pub. No.: US 2012/0298664 A1
(43) Pub. Date: Nov. 29, 2012

(54) Paired magnetic spoon rest and insulating means

(76) Inventor: Dean DeVolpi, Las Vegas, NV (US)

(21) Appl. No.: 13/478,701

(22) Filed: May 23, 2012

Related U.S. Application Data
(60) Provisional application No. 61/489,963, filed on May 25, 2011.

(51) Int. Cl. A47J 36/00; A47J 36/06; A47J 45/10

(52) U.S. Cl. 220/212; 220/753; 206/223

(57) ABSTRACT

This invention relates to cooking utensils having at least dual means to mechanically stabilize a cooking utensil to a Pan/pot/holding tray or lid where the effort to place it in a set location is user friendly as well as the ability to remove the utensil at a static state is likewise effortless. This system requires at least one matching pair of magnets and a second mechanical means to stabilize the utensil and a means to protect the magnet on the heated source.

Claim the benefit of provisional patent 61/489,963 dated May 25, 2011.

### FIELD OF THE INVENTION

The present invention relates generally to cooking utensil holders for pots, pans, serving trays and covers, and more particularly to a cooking utensil holder for securing a cooking utensil to a pot, pan, serving tray, cover or other cooking/heating/serving container handle where the utensil cooking end is positioned above the open container or the cover. And provides for a method of preventing the hand from heat with an insulating handle system.

### BACKGROUND OF THE INVENTION

Handling food spillage and dripping from the end of a kitchen utensil, such as a spoon, after stirring the contents of a pot, pan, serving tray, cover, or cooking container has long been a problem. One solution for example, has been to place a dish or custom spoon rest on the stove or an adjacent surface, into which the wet end of the utensil is placed. Unfortunately, movement of the utensil from the cooking container across the stove allows drips and spills from the utensil cooking end to splash on the stove and create a food-splattered stove surface. The dish also collects spillage, and must be cleaned. Also the handles on pans are not maximized for preventing high heat flow at the hand, in some cases like cast iron pans this can be too hot for the hand and also for magnets in our devices.

In the past using one means of attachment allowed minimal torque to cause a failure in the holding IE to unsecured, not have a comfortable feel to the attachment, or in some cases make it difficult to remove or even some will slide out which are not human factors oriented. Thus we need at least two methods of attachment, where at least one method needs to be at last one set of paired magnets for ease of release and the other can be mechanical like another set of paired magnets or even a grove.

Padock U.S. Pat. No. 1,965,354 teaches sleeves for handles: Bell U.S. Pat. No. 4,197,611 teaches us a silicone handle sleeve with continuous axial ribs. Bodum D630,888; Matineau D597,395 with outer ribs; Zanner 20060237470 is continuous axial non contact. My claimed invention is not linear/continuous my art for example would be a wave pattern, square wave pattern and so on which minimizes heat transfer to a new level and also prevents slipping. Swinford D401,473 shows minimal outer radiating ribs.

A single magnet in spatulas is not new or novel as taught by Bennet U.S. Pat. No. 2,873,136 Magneric spatula. Magnets in other kitchen ware are taught by Wilm U.S. Pat. No. 2,641,793 Pot Holder; Lin U.S. Pat. No. 7,043,844; Two magnets have been taught by Budreck U.S. Pat. No. 3,111,736; Geibel U.S. Pat. No. 5,501,342; and multiple for tools Coleman U.S. Pat. No. 6,923,317; Morita U.S. Pat. No. 5,125,134;

Single mechanical resting means for utensils have been used as taught by Jurgich U.S. Pat. No. 4,867,410, Gaskill U.S. Pat. No. 5,518,211; and by Qualiano U.S. 2004/0262459 A1; Dwyer U.S. Pat. No. 5,678,790; Munari 6032,822, Scott 5,105,963 also includes single magnetic means. These do not prevent the torque problem or a non latched issue which my invention the dual mechanical means does and therefore have never been accepted as useful in the market at solving a problem to the satisfaction of the human factors needed. This invention meets the expectations of the user overcoming the confines of the previous noted arts.

Blum teaches us using magnets to keep a pan holder together. Blum U.S. Pat. No. 7,669,291 but does not anticipate attaching kitchen utensils to the handle.

Grips have been made with insulating materials as Bratton teaches us in D258,861, and new ones Borhofen self releasing ones U.S. Pat. No. 7,410,076 B2.

More than one means of attachment with one being a magnet including pairs are taught by Dunmore U.S. Pat. No. 2,220,049; Cotutsca U.S. Pat. No. 4,901,456; Chandonnet U.S. Pat. No. 4,875,654; Cheng U.S. Pat. No. 6,473,946; Fujimoto U.S. Pat. No. 4,231,137; Loofboro U.S. Pat. No. 2,648,884;

Multiple magnets for mechanical stabilization alignment and use have been taught by Hawley U.S. Pat. No. 4,568,301; Zbegner U.S. Pat. No. 5,188,555; Hall U.S. Pat. No. 5,060,94; and Dokoupil U.S. Pat. No. 6,413,138; And matching magnets for interlocking similar items have been useful in Lee 20100229643

### SUMMARY OF THE INVENTION

It is accordingly a principal objective of the present invention to provide a improved holder to releasably fasten a cooking utensil to a pot, pan, serving tray, covering or container in a manner that permits food on the wet or “cooking” end of the utensil to drip back into the container and/or keeping it cleanly. It is a more particular objective to provide a holder to releasably fasten a cooking utensil to a pot, pan, serving container, lid or container handle, with the cooking end of the utensil supported above the open container or above the lid. This is accomplished by two distinct sets of mechanically holding aligning locations for the utensils with respect to the handle where at least one set is dual attracting magnets. With another object of this invention keeping heat from degrading the strength of the magnet. This holder is not limited to attaching to handles, to the point it can be attached to pots/pans with no handles, or non adaptable handles due to their geometry.

It is so a principle objective of this present invention an improved holder to reasably prevent high heat at a handle, in many applications the pot/pan/tray is left on at a high heat for a cooking and the handle in a cast iron pan can hit high temperatures due the homogeneous nature of a sold pan/pot. Others have addressed this with very lose fitting handles that you remove till it is needed which has several disadvantages, a lose fit can lead to the pan slipping or even requiring very strong hands to hold down the holder.

This present invention through minimized areas of conductive heat transfer by decreasing the in contact surface at rest yet still holding the handle firmly and even has better anti-slide off because of the internal added groves in the longitude of the length of the handle in a perpendicular fashion. One such pattern we will use is similar to a serrated knife with a wave in the axial direction with ups and down valleys on these ribs to reduce the actual contact area when at rest in cases to minimizes heat transfer. We also maximize the distance the conducted heat has to travel to reach the hand or magnet with the valleys matching the outer circular radiating ribs.

In other universal handles because of a lose fit it forces a person to then hold with more force hence increases the heat transfer to the hand. Another feature of the present invention allows in one product to have two sizes depending on the side you insert the handle. With this there will be a better fit, two options thus doubling the probability of a good fit. using one or the other side. With the outer circular radiating ribs radiating axially around the entire handle perpendicular to the length of the handle. Another benefit to this design is a person can cut the handle off at a outer circular radiating rib to shorten it to match the pan with a finished look.

Another method of minimizing heat transfer is to mix in super insulators into the handle like the internal area with materials like ceramic or glass hollow balls to restrict heat transfer rates, we are not limited by just these materials there are other insulating materials to do this. An object of this invention is to have the external ribs perpendicular to the handle is ideal for hand ergonomics for gripping purposes, when a person does not perceive a slippery feel the physical clamping force is minimized and correspondingly the heat transfer rate is lower. As seen in other handles the outer ribs radiate axially this is a natural slip which requires additional force to hold the pan and increases the heat transfer rate, we overcome this by putting the ribs at right angles to the way a hand slides off, with sharp edges.

Also by having these ribs longer than the norm, it provides longer distance for the heat to travel and a better venting system. These outer ribs also are of a sufficient durometer to prevent collapsing of the rib where the hand would not come in contact with the inner shell or shortening the distance the conductive heat would transfer. If collapsing to the inner shell that would cause the higher heat area of the inner shell to conduct its heat to your hand.

Major issues with old art magnetic related spoon rests is heat could degrade the magnets, the magnets needed need a pairing of today's state of the art strength to have a balanced human engineered product, to get a human factors force you need to use two magnets and with only one contact point the torque in a small area is too high for the utensils to stay in place or lock into the proper position without frustrating the user. By adding a second location with a second mechanical method a distance x we give it a substantial anti-torque mechanism so the utensil stays in place yet is easily removed still. Some systems were to hard to remove or unbalanced to easy to be disrupted from the static position. This system solves all these issues to make a marketable thus user friendly product. That is why as of this date the old ways have not been accepted into the market.

Today's strong magnets, the rare earth ones have tremendous pull power and it is found that we need this strength to weight ratio to have the “feel” or human factors that is appropriate to guide the magnets to find their way. A problem with the best rare earth magnets is they have environmental issues that affect their life. One of them is they break when they hit hard surfaces directly and repeatedly. We solve this by encapsulating the magnet in a shock absorbing material. Such materials that can protect is silicone and plastics. Second they must be coated to attempt to minimize oxidation that also can cause a critical failure, they still can have problems with wear if not protected. This plating also is susceptible to wear. To minimize the wear silicone and plastic resolve this.

Magnets can lose their magnetic properties by heat. Direct contact to pan/pot and pan/pot handles can be detrimental to the life of the magnet. There are various temperature ranges for magnets which in general get more expensive depending on the range. Thus insulating the heat thereby minimizing heat transfer to the magnets is an objective to minimize manufacturing cost. We accomplish this by using various materials like silicone, plastics, and other thermally insulating materials and our ribbing handle.

Because magnetic force decreases by the square of the distance we need opposing magnets to pull themselves into place. By placing two magnet pairs that attract one another we have a needed “feel” to place/guide the utensil onto the resting place. To prevent it from overheating we have a silicone plastics or other material holder/spacer, this increase the distance between the magnets which exponentially loses its holding strength. This silicone can also have ceramic hollow ball insulators mixed in it. This said silicone also can double/triple as a protector to be a shock absorber protector of the magnet itself that is brittle vulnerable to breaking, and environmental to prevent oxidation .

The kitchen utensils can range from spoons, pourers, spatulas, handle covers, knives, blades, made of either single or multiple materials like, wood, plastic, silicone, metals, ceramics, and not limited to these materials.

Further understanding of the invention, how it achieves the stated objectives, and its advantages can be obtained from consideration of the following detailed description of embodiments of the invention taken in conjunction with the drawings, in which:

### BRIEF DESCRIPTION OF THE DRAWINGS

FIG. 1 is a perspective view of a embodiment of a pan with integral handle with two magnets with insulating method made in accordance with the invention;

FIG. 2 is a exploited view of a pan's integral handle of the FIG. 1 with two magnets with insulating method made in accordance with the invention;

FIG. 3 is a perspective view of a embodiment of a pan handle sleeve with two magnets with insulating method made in accordance with the invention;

FIG. 4 is a perspective view of a kitchen utensil with integral two magnets with insulating made in accordance with the invention;

FIG. 5 is a perspective view of a ribbed handle with integral three magnets with insulating ribs made in accordance with the invention;

FIG. 6 is a cross section view of a circular radiating ribbed handle with integral three magnets with insulating ribs made in accordance with the invention;

FIG. 7 is a 3 dimensional view of a circular radiating ribbed handle with integral three magnets with insulating ribs made in accordance with the invention;

FIG. 8 is a end view of a circular radiating ribbed handle with integral three magnets with insulating ribs made in accordance with the invention;

### DETAILED DESCRIPTION OF EMBODIMENTS OF THE INVENTION

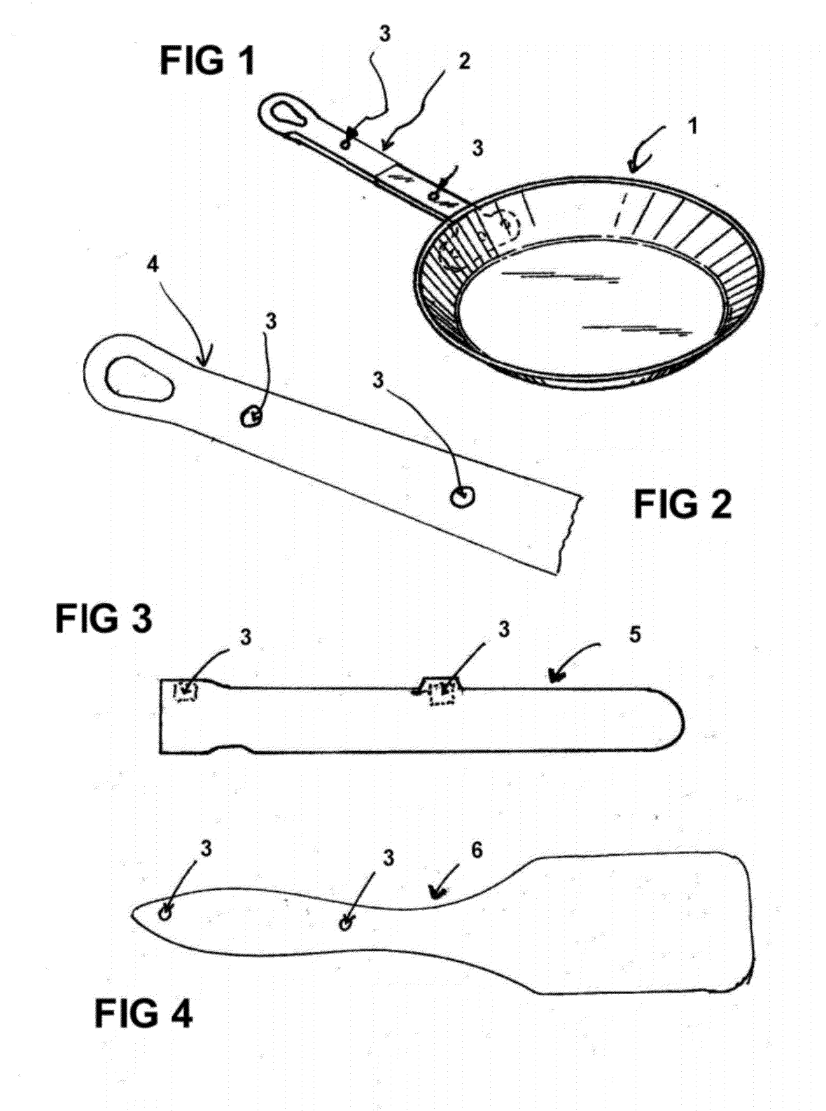

Referring now to the drawings, FIGS. 1-8 show a variety of magnet pockets 3 for attracting the utensils 6 to the pan 1.

FIG. 1 shows Pan 1, with a handle 2 with two magnet locations 3.

FIG. 2 shows the details of the handle 4 with two pockets with insulated magnets attached 3.

FIG. 3 shows two magnet pockets 3 in a sleeve handle 5 that can slide onto various pan handles.

FIG. 4 shows a utensil 6 with two magnet locations 3 in it. Such that this utensil can attach and align to the Pans handle in FIG. 1, FIG. 2, and the sleeve in FIG. 3.

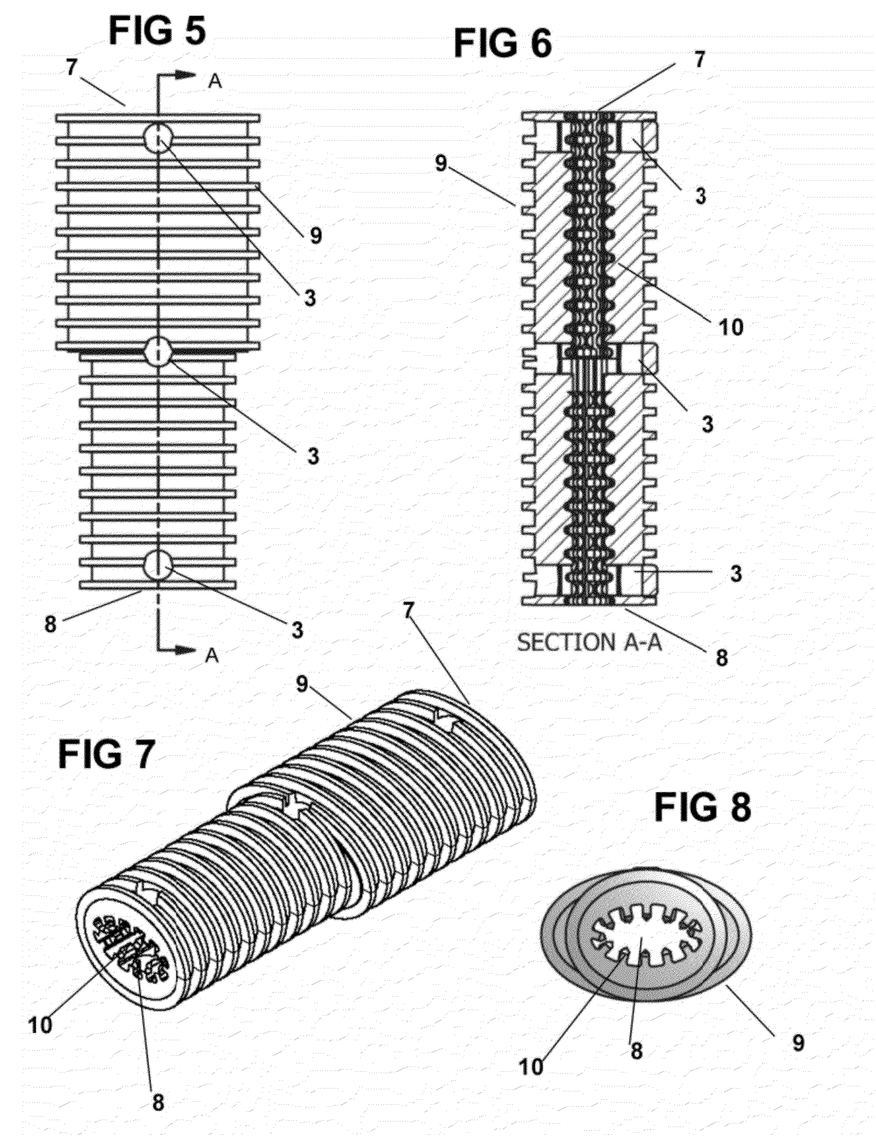

FIG. 5 shows a handle with means of defusing heat with large opening 7, three sets of magnets in pockets 3, smaller opening 8, outer heat diffusing ribs 9. The utensil in FIG. 4 locks onto the paring magnets in the three places but can attach to the forward pair or the back pair.

FIG. 6 shows a cross section of FIG. 5 with magnet pockets 3, large opening 7, and small opening 8, circular radiating heat diffusing ribs 9, and internal heat diffusing wave pattern ribs 10.

FIG. 7 shows, a handle with a large opening 7, and small opening 8 with outer circular radiating heat diffusion ribs 9, and internal heat diffusing wave pattern ribs 10.

FIG. 8 shows the end of the handle from the small side 8, with circular radiating heat diffusing outer ribs 9, and internal heat defusing ribs with a wave pattern 10.

While the invention has been described in relation to particular embodiments, those skilled in the art will recognize various modifications of structure elements, material and the like which may further facilitate application of the invention, while still falling within the scope of the invention.

What I claim is:

1. A method for minimizing high heat transfer to the hand when grabbing a pan handle with a sleeve comprising:
A Silicone sleeve with inner ribs with a high low pattern in the axial ribs that minimizes surface area contact that radiate in axially to the length of the outer lining of the sleeve.

2. Said silicone sleeve in claim 1 material may be composed of other insulating materials.

3. A sleeve in claim 1 with outer circular radiating ribs that radiate perpendicular to the length of the said lining of the sleeve in claim 1. These ribs are of sufficient strength to prevent the hand from coming in full contact with the inner lining.

4. A sleeve in claim 1 that has two inner diameters surface areas accessible on opposite ends.

5. A sleeve in claim 3 that has two inner diameters surface areas on opposite ends.

6. Said silicone in claim 3 material may be composed of other insulating materials.

7. A method for supporting a kitchen utensil above a pot/pan/tray or cover comprising:
(a) A pot/pan/tray or cover with one magnet embedded onto a pot/pan/tray or cover to lock or stabilize onto it a kitchen utensil to rest above or near the cooking/resting area of the pan with one or more second mechanical means to prevent a torque rotational movement.
(b) A kitchen utensil with at least one magnet that adheres to the pot/pan/tray or cover in addition to the second mechanical means on said pot/pan/tray or cover to prevent torque rotational movement.

8. The second mechanical means to prevent a rotational movement in claim 7 that is a magnet.

9. The second mechanical means to prevent a rotational movement in claim 7 that is a holder.

10. The second mechanical means to prevent a rotational movement in claim 7 that is a grove.

11. The second mechanical means to prevent a rotational movement in claim 7 that is a hooking material.

12. The magnet(s) in claim 7 where magnet(s) has an insulating means.

13. The second mechanical means in claim 8 has an insulating means.

14. A method for supporting a kitchen utensil above a pot/pan/tray or cover comprising:
(a) A pot/pan/tray or cover with one magnet embedded onto a pot/pan/tray or cover to lock or stabilize onto it a kitchen utensil to rest above or near the cooking/resting area of the pot/pan/tray or cover.
(b) A kitchen utensil with at least one magnet embedded that conforms to the second mechanical means on said pot/pan/tray or cover to prevent torque rotational movement with one or more second mechanical means to prevent a torque rotational movement.

15. The second mechanical means to prevent a rotational movement in claim 14 that is a magnet.

16. The second mechanical means to prevent a rotational movement in claim 14 that is a holder.

17. The second mechanical means to prevent a rotational movement in claim 14 that is a grove.

18. The second mechanical means to prevent a rotational movement in claim 14 that is a hooking material.

19. The magnet(s) in claim 14 where magnet(s) has an insulating means.

20. The second mechanical means in claim 15 has an insulating means.
